(19) United States
(12) Patent Application Publication
(10) Pub. No.: US 2015/0052236 A1
(43) Pub. Date: Feb. 19, 2015

(54) LOAD BASED TARGET ALTERATION IN STREAMING ENVIRONMENTS

(71) Applicant: CISCO TECHNOLOGY, INC., San Jose, CA (US)

(72) Inventors: Eric Colin Friedrich, Somerville, MA (US); Matthew Francis Caulfield, Clinton, MA (US); Carol Etta Iturralde, Framingham, MA (US); Mahesh Vittal Viveganandhan, Cupertino, CA (US); Scott C. Labrozzi, Cary, NC (US)

(73) Assignee: CISCO TECHNOLOGY, INC., San Jose, CA (US)

(21) Appl. No.: 13/967,183

(22) Filed: Aug. 14, 2013

(51) Int. Cl. H04L 29/06; H04L 12/26

(52) U.S. Cl. CPC H04L 65/60; H04L 43/08
USPC 709/224

(57) ABSTRACT

A method is provided in one example embodiment and includes receiving, at a virtual server, a request for video content from a client device; identifying a policy for a set of transform sessions; accessing a resource monitor in order to evaluate current load conditions associated with the virtual server; and determining an action to take based on the current load conditions.

### TECHNICAL FIELD

This disclosure relates in general to the field of communications and, more particularly, to a system, an apparatus, and a method for load based target alteration in streaming environments.

### BACKGROUND

End users have more media and communications choices than ever before. A number of prominent technological trends are currently afoot (e.g., more computing devices, more online video services, more Internet video traffic), and these trends are changing the media delivery landscape. Separately, these trends are pushing the limits of capacity and, further, degrading the performance of video, where such degradation creates frustration amongst end users, content providers, and service providers. In many instances, the video data sought for delivery is dropped, fragmented, delayed, or simply unavailable to certain end users.

Adaptive Streaming is a technique used in streaming multimedia over computer networks. While in the past, most video streaming technologies used either file download, progressive download, or custom streaming protocols, most of today's adaptive streaming technologies are based on hypertext transfer protocol (HTTP). These technologies are designed to work efficiently over large distributed HTTP networks such as the Internet.

HTTP-based Adaptive Streaming (HAS) operates by tracking a user's bandwidth and CPU capacity, and then selecting an appropriate representation (e.g., bandwidth and resolution) among the available options to stream. Typically, HAS would leverage the use of an encoder that can encode a single source video at multiple bitrates and resolutions (e.g., representations), which can be representative of either constant bitrate encoding (CBR) or variable bitrate encoding (VBR). The player client can switch among the different encodings depending on available resources. Ideally, the result of these activities is little buffering, fast start times, and good video quality experiences for both high-bandwidth and low-bandwidth connections.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1A is a simplified block diagram of a communication system for providing load based target alteration in streaming environments in accordance with one embodiment of the present disclosure;

FIG. 1B is a simplified block diagram illustrating one possible example implementation associated with the communication system;

FIG. 1C is a simplified schematic diagram illustrating a common format conversion example associated with the present disclosure;

FIG. 1D is a simplified block diagram illustrating an example pipeline dataflow associated with the present disclosure;

FIG. 1E is a simplified table representation associated with an example workflow for the communication system;

FIG. 1F is a simplified flowchart illustrating potential operations associated with the communication system in accordance with certain embodiments of the present disclosure; and

FIG. 2 is a simplified block diagram illustrating possible example details associated with particular scenarios involving the present disclosure.

### DETAILED DESCRIPTION OF EXAMPLE EMBODIMENTS

### Overview

A method is provided in one example embodiment and includes receiving, at a virtual server, a request for video content from a client device; identifying a policy for a set of transform sessions; accessing a resource monitor in order to evaluate current load conditions associated with the virtual server; and determining an action to take based on the current load conditions. The current load conditions can include: a) a central processing unit (CPU) utilization level; b) a memory utilization level; c) an ingress and an egress network utilization level; and d) a storage input/output (IO) level. The action can include signaling that at least some of the transform sessions should be limited to a certain bit-rate or a certain bandwidth.

In certain scenarios, the method can include detecting an overload condition; and using an on-demand encapsulation engine to determine particular transform sessions that would be subject to pruning or pacing. Other examples can include implementing a popularity-based pruning scheme by favoring bit-rate profiles that are more popular to a plurality of client devices; and pruning bit-rate profiles that are less popular to the plurality of client devices.

In yet other examples, the method could include using metadata to determine particular transform sessions that correspond to contents that do not provide significant quality increases at higher bit-rates; and pruning bit-rate profiles that correspond to the particular transform sessions. Other methods may include determining that new resources at the virtual server are available; generating a new policy based on the new resources; and adding new bit-rate profiles to be made available to additional client devices.

In certain cases, the method could include providing a proactive notification when a plurality of video sessions are already in progress, where the notification is provided in response to an event for which at least one existing bit-rate cannot be maintained for at least some of the video sessions, and where the client device is instructed to downshift to a bit-rate profile lower than a current bit-rate profile being used by the client device.

In yet other scenarios, the method can include providing, by the resource monitor, a notification to each of the transform sessions to indicate an action for the client device to throttle down such that the client device responds by no longer sending high-bit-rate requests to the virtual server. In certain instances, an updated output manifest file is produced in which the transform sessions do not include a high-bit-rate profile for the client device.

### EXAMPLE EMBODIMENTS

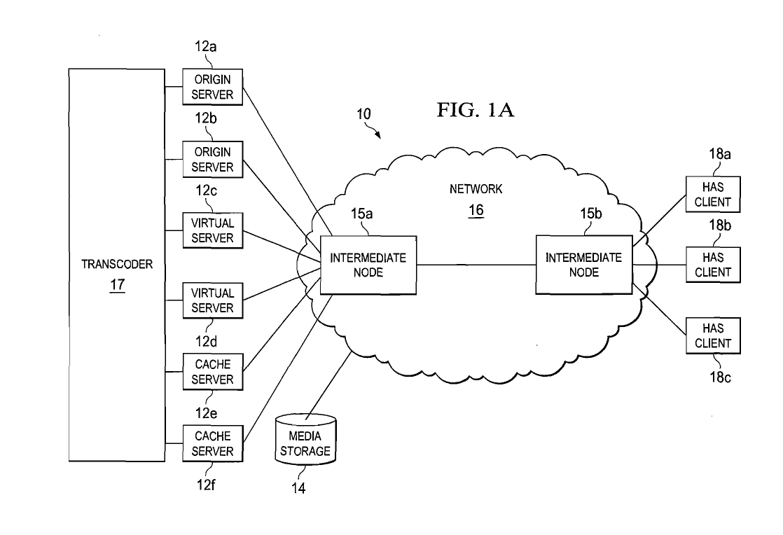

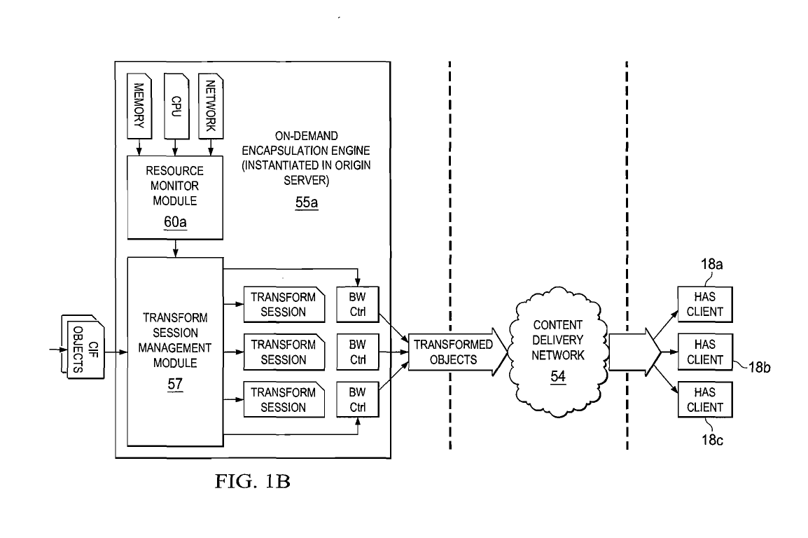

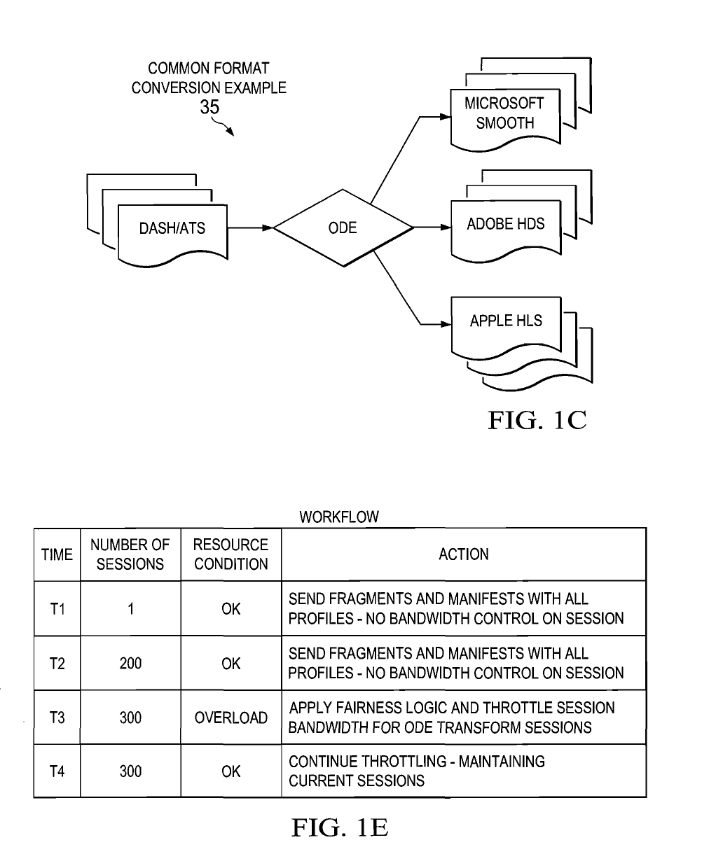

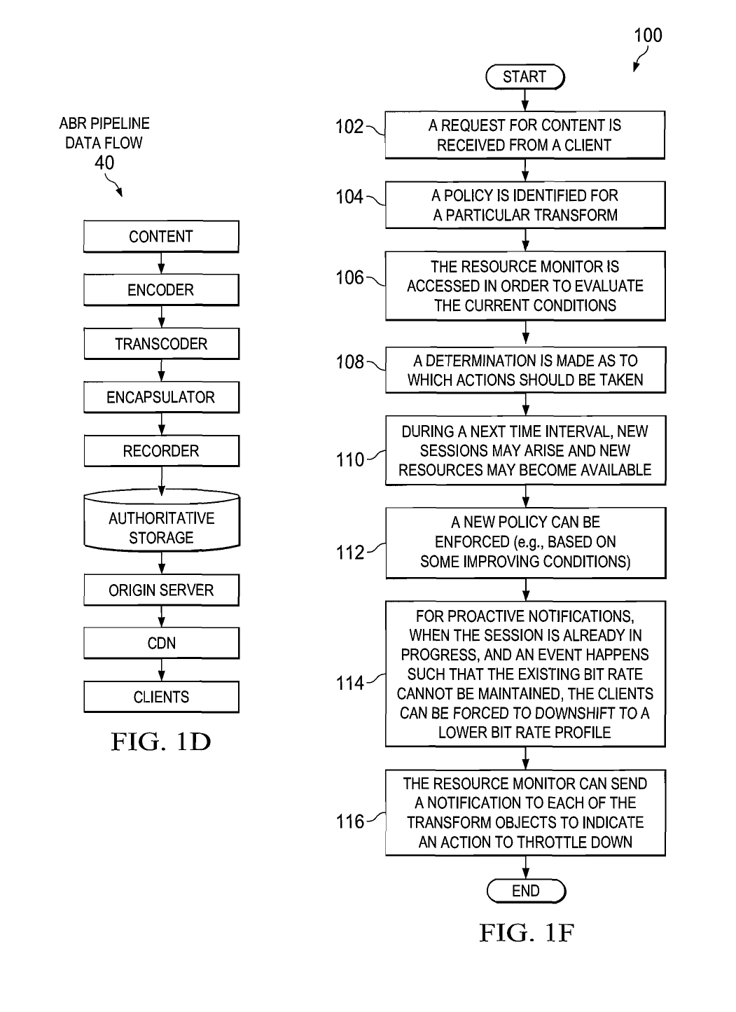

Turning to FIG. 1A, FIG. 1A is a simplified block diagram of a communication system 10 configured for providing load based target alteration in streaming environments, for example, among adaptive bit-rate (ABR) flows for a plurality of clients in accordance with one embodiment of the present disclosure. Communication system 10 may include a plurality of origin servers 12a-b, virtual servers 12c-d, cache servers 12e-f, a media storage 14, a network 16, a transcoder 17, a plurality of hypertext transfer protocol (HTTP)-based Adaptive Streaming (HAS) clients 18a-c, and a plurality of intermediate nodes 15a-b. Note that the originating video source may be a transcoder that takes a single encoded source and “transcodes” it into multiple rates, or it could be a “Primary” encoder that takes an original non-encoded video source and directly produces the multiple rates. Therefore, it should be understood that transcoder 17 is representative of any type of multi-rate encoder, transcoder, etc.

Servers 12a-f are configured to deliver requested content to HAS clients 18a-c. The content may include any suitable information and/or data that can propagate in the network (e.g., video, audio, media, any type of streaming information, etc.). Certain content may be stored in media storage 14, which can be located anywhere in the network. Media storage 14 may be a part of any web server, logically connected to one of servers 12a-f, suitably accessed using network 16, etc. In general, communication system 10 can be configured to provide downloading and streaming capabilities associated with various data services. Communication system 10 can also offer the ability to manage content for mixed-media offerings, which may combine video, audio, games, applications, channels, and programs into digital media bundles.

Note that, as a general proposition, on-demand encapsulation is both memory intensive and computing intensive (e.g., the system receives bits, rearranges bits, potentially encodes certain content, etc.). On-demand encapsulation can be used to optimize storage and bandwidth resources in an Internet Protocol (IP) video distribution system that utilizes adaptive bit-rate streaming. While on-demand encapsulation optimizes the storage and bandwidth resources, the encapsulation process is compute intensive. The process itself involves data parsing, re-sequencing, and encryption.

Typically, there is a finite number of on-demand encapsulation resources. Finite compute resources are allocated to perform on-demand encapsulation based on estimates of a certain working set size (the number of assets being accessed and, hence, encapsulated at a given time). However, there are certain times where the estimates might not be accurate and the system may be required to support a larger working set with the same amount of compute resources. Hence, optimizing these resources becomes critical, particularly so as the system becomes overloaded (e.g., oversubscribed).

In accordance with certain techniques of the present disclosure, the architecture of FIG. 1A can offer a profile pruning scheme that may be used to increase the number of unique assets in the working set, by reducing the number of profiles, based on the current load of the system. By optimizing the number of profiles in the target format assets (e.g., based on the current load of the on-demand encapsulation system), the system can increase the number of unique assets delivered per-server. Moreover, such a framework could effectively handle long-tail asset access with on-demand encapsulation with a finite amount of system resources.

It should be noted that such a load based target alteration paradigm can be deployed regardless of the underlying transport protocol's (e.g., TCP, SCTP, MP-TCP, etc.) behavior. Note also that the mechanism described here may be used in different ways in different applications (such as applications different from the examples given below) to achieve enhanced bandwidth management and performance.

Turning to FIG. 1B, FIG. 1B includes an on-demand encapsulation engine 55a, which in this example is instantiated in an origin server. This particular architecture also includes a content delivery network 54 that can receive transformed objects from on-demand encapsulation engine 55a. The on-demand encapsulation engine could be instantiated in origin servers, in virtual servers, in cache servers, in intermediate nodes, in data centers, in the clients themselves, etc.

On-demand encapsulation engine 55a may include a transform session management module 57, a resource monitor module 60a, a memory, one or more processors, and a network interface. In this example, common intermediate format (CIF) objects flow into on-demand encapsulation engine 55a to be received by transform session management module 57. Transform session management module 57 has a logical coupling to multiple transform session elements, along with a coupling to bandwidth (BW) control elements, as is illustrated.

One proposed scheme of the present disclosure involves manifest pruning in which the highest bit-rate profiles are removed from the manifest file. These higher bit-rate profiles typically have more data in them and, therefore, it would be logical to remove these profiles, as new sessions are created. A second proposed scheme of the present disclosure involves implicit pruning. In the case of implicit pruning, the manifest file is not necessarily altered and, instead, modifications can be made on the server side. For example, this approach could prohibit clients from reaching the highest bit-rate profiles. A third proposed scheme of the present disclosure relates to fairness, where not all profiles are necessarily equal, and the architecture can evaluate which profiles are most popular and, therefore, should be maintained. The important point in these schemes is that the load on the system is being used as a central input for adjusting behavior.

In operation, the resource monitor function keeps track of the number of content transform sessions. When a new object (e.g., transform session) is added, the resource monitor would track this updated information. The resource monitor also knows the current state of the existing transform sessions. The resource monitor systematically monitors the load on computing resources, the memory, the network, I/O, etc.

As a new object is created, the resource monitor can be accessed, or otherwise engaged, consulted, etc. Based on the information being maintained by the resource monitor, intelligent decisions can be made about how best to accommodate the new object. For example, based on the existing conditions such as a number of sessions being tracked, the system load, etc., higher bit-rate profiles would not be used.

A second part associated with this framework involves curating existing transform sessions. Consider a steady-state case in which there are no new sessions being created, however existing sessions still need to be intelligently managed. The resource monitor can proactively notify each of the transform sessions to throttle down (e.g., limit the delivery rate over a certain time interval). In essence, the system is able to influence transform policies based on the existing state.

In operation, on-demand encapsulation can be implemented in specialized servers called the virtual servers. The virtual server is an origin server in which the client-specific delivery formats are produced on-demand. The virtual servers can implement the on-demand encapsulation engine in certain embodiments of the present disclosure. Alternatively, the on-demand encapsulation engine can be provisioned in any other suitable location (including on client devices themselves).

A typical origin server does not manipulate content. A virtual server is capable of receiving content, recording the content, and interacting with the on-demand encapsulation engine in order to transform the content when the request for content is received. The CDN can steer the request to the appropriate node. While the CDN may be aware of the locations of the virtual servers and the standard origin servers, the client is generally unaware of this information. Hence, the CDN can find the most suitable place from which the content should be serviced.

A media asset that should be delivered using the on-demand encapsulation procedure can be first packaged as a common intermediate format (CIF) representation. This can be done, for example, as part of the asset preparation systems. In addition to the asset, additional metadata and control data is specified to enable on-demand encapsulation. The common intermediate format and the target specific metadata is stored in shared network storage that can be accessed by the virtual servers.

The common intermediate format usually contains a larger set of profiles to address many client types (e.g., 15 encoding profiles). The number of profiles that has to be present in the target format asset under normal conditions is defined in the virtual asset description for that target format. When a request for the target format (the client specific delivery format) arrives, an asset level transform context is created and persisted until there is active requests for that asset. The context can be unloaded after a period of inactivity for that asset.

An internal service monitor function (e.g., resource monitor module 60a) can monitor the system resources during the encapsulation process. At each asset transform context creation time, the system load is checked to determine the number of profiles to be included. For the higher bit-rate profiles (having more bits and using more compute and storage bandwidth) encrypt and encapsulate can be eliminated in the new transform context, and then the manifest files can also reflect this condition.

Turning to FIG. 1C, FIG. 1C can be used to understand some of the bandwidth challenges encountered in a network that includes HAS clients. The following foundational information may be viewed as a basis or context associated with load based target alteration for on-demand encapsulation systems. Adaptive streaming video systems make use of multi-rate video encoding and an elastic IP transport protocol suite (typically hypertext transfer protocol/transmission control protocol/Internet protocol (HTTP/TCP/IP), but could include other transports such as HTTP/SPDY/IP, etc.) to deliver high-quality streaming video to a multitude of simultaneous users under widely varying network conditions. These systems are typically employed for “over-the-top” video services, which accommodate varying quality of service over network paths.

In adaptive streaming, the source video is encoded such that the same content is available for streaming at a number of different rates (this can be via either multi-rate coding, such as H.264 AVC, or layered coding, such as H.264 SVC). The video can be divided into “chunks” of one or more group-of-pictures (GOP) (e.g., typically two (2) to ten (10) seconds of length). HAS clients can access chunks stored on servers (or produced in near real-time for live streaming) using a web paradigm (e.g., HTTP GET operations over a TCP/IP transport), and they depend on the reliability, congestion control, and flow control features of TCP/IP for data delivery. HAS clients can indirectly observe the performance of the fetch operations by monitoring the delivery rate and/or the fill level of their buffers and, further, either upshift to a higher encoding rate to obtain better quality when bandwidth is available, or downshift in order to avoid buffer underruns and the consequent video stalls when available bandwidth decreases, or stay at the same rate if available bandwidth does not change. Compared to inelastic systems such as classic cable TV or broadcast services, adaptive streaming systems use significantly larger amounts of buffering to absorb the effects of varying bandwidth from the network.

In a typical scenario, HAS clients would fetch content from a network server in segments. Each segment can contain a portion of a program, typically comprising a few seconds of program content. [Note that the term ‘segment’ and ‘chunk’ are used interchangeably in this disclosure.] For each portion of the program, there are different segments available with higher and with lower encoding bitrates: segments at the higher encoding rates require more storage and more transmission bandwidth than the segments at the lower encoding rates. HAS clients adapt to changing network conditions by selecting higher or lower encoding rates for each segment requested, requesting segments from the higher encoding rates when more network bandwidth is available (and/or the client buffer is close to full), and requesting segments from the lower encoding rates when less network bandwidth is available (and/or the client buffer is close to empty).

FIG. 1C is a simplified schematic diagram illustrating a common format version example 35 associated with the present disclosure. A fundamental problem in content delivery is the need to serve a wide variety of client devices. For example, in the context of ABR video, these various client device types each require specific metadata and specific video formats. The following are examples of prevalent ABR client types: Microsoft HTTP Smooth Streaming (HSS), Apple HTTP Live Streaming (HLS), and Adobe Zeri (HDS). A server that handles requests from a heterogeneous pool of ABR clients should store its content in a form that can be easily translated to the target client format. In a simple implementation, such a server could store a separate copy of a piece of content for each client device type. However, this approach negatively impacts storage and bandwidth usage. In a caching network (CDN), for example, multiple formats of the same piece of content would be treated independently, further exacerbating the problem.

On-demand encapsulation (ODE) attempts to address several issues associated with storage and bandwidth. With ODE, a single common format representation of each piece of content can be stored and cached by the server. Upon receiving a client request, the server can re-encapsulate the common format representation into a client device format. ODE provides a tradeoff between storage and computation. While storing a common format representation incurs lower storage overhead, re-encapsulating that representation on-demand is considerably more expensive (in terms of computation) than storing each end-client representation individually.

A common format should be chosen to meet the needs of all client device types. Moreover, the common format and its associated metadata should be easily translated into either client format (as depicted in the example of FIG. 1C). Adaptive Transport Stream (ATS) is an ABR conditioned moving picture experts group (MPEG)-transport stream (TS) (MPEG2-TS) with in-band metadata for signaling ABR fragment and segment boundaries. Dynamic Adaptive Streaming over HTTP (DASH) is a standard for describing ABR content. The common format specification is fundamental to ODE.

FIG. 1D is a simplified block diagram illustrating an example pipeline dataflow 40 associated with an ABR application. The ABR content workflow may be understood as a pipeline of functional blocks strung together for delivering ABR content to clients. Content can arrive at the system in a raw format. The encoding stage can convert the raw format content into a compressed form at a single high-quality level. The transcoding stage produces multiple lower-quality versions of the content from the single high-quality version. The encapsulation stage typically prepares the content at a quality-level for a specific end-client type (e.g., Smooth, HLS, etc.). The recording stage accepts the set of contents, including formats for multiple clients with multiple quality-levels, and saves them to an authoritative store. At the origination stage (upon receiving a request) serves content based on client type and the requested quality level.

The CDN can cache content in a hierarchy of locations to decrease the load on the origination stage and, further, to improve the quality of experience for the users in the client stage. Finally, the client stage can decode and present the content to the end user. The pipeline can be similar for both Live and video on-demand (VoD) content, although in the case of VoD the recording stage may be skipped entirely. For VoD, content can be stored on a Network-Attached Storage (NAS) for example.

Some of the more significant aspects of ODE take place between the encapsulation and origination stages of the pipeline. The encapsulation stage produces the common format media and indexing metadata. The recording stage accepts the common format and writes it to storage. The origination stage reads the common format representation of content and performs the encapsulation when a request is received from a particular client type.

Manifest pruning is a practice in many ABR ecosystems. In most scenarios, the manifest files are pruned to support a network and to support the client-based filtering of profiles. However, these activities do not account for server and content transformation load. One aspect of the present disclosure addresses the issue of content transformation load of the server to make intelligent decisions on the profile sub-set that is optimal for efficient server utilization. Because there are many ABR variants, not all ABR clients are amenable to mid-stream manifest changes. The following examples reflect some (but not all) of the methods that can be employed in the context of manifest pruning.

A first method is associated with Dynamic Adaptive Streaming over HTTP (DASH) media presentation description (MPD) based manifests. DASH supports the concept of periods and adaptation sets. For linear streaming use cases, based on the server load, a new period can be created with a modified list of profiles within the adaptation set for that period. The on-demand-re-encapsulation engine of FIG. 1B can use the server load conditions and determine the profiles that should be advertised in the new period.

A second method is associated with HLS. Since the variant manifest is not retrieved after the session setup, one method for mid-stream profile handling involves using a redirect protocol that redirects the requests for higher bit-rate fragments to equivalent fragments at lower bit-rates. A third method is associated with HSS. A composite manifest file (e.g., a playlist of manifests) can be used to emulate the DASH multi-period concept. The composite manifest can be used in video on-demand (VOD) scenarios. Each manifest entry in the composite file could be dynamically resolved by the on-demand-encapsulation engine to contain the set of profiles for the current load conditions.

One example implementation associated with load based target alteration involves implicit pruning without manifest file modifications. Hence, one method to force the clients away from higher bit-rate/resource consuming streams is to use a pacing technique. Under higher loads, the on-demand encapsulation engine can pace the downloads of higher bit-rate profiles to values lower than the native rate of the video, forcing the clients to downshift to the next profile available.

This can alleviate the load on the server, as the server would not see the requests for higher bit-rate fragments. Since the pacing value can be altered any time during the session, this scheme can handle mid-session scenarios. In order to prevent frequent oscillations among profiles, the preferred profiles should also be paced to a value that is sufficient for the client to stay at the current quality level, but not upshift. Unlike the manifest pruning scheme, this scheme can be applied to stream setup (for newer clients), mid-stream changes (for existing clients), and automatic fallback to higher profiles when server resources are available.

Another example implementation associated with load based target alteration involves fairness/candidate transform sessions for pruning/pacing. When an overload condition is detected, the on-demand encapsulation engine can determine the transform sessions that would be subject to pruning or pacing. It is not required to prune/pace all of the transform sessions. The pruning could continue until there is sufficient spare capacity to admit newer sessions. The following are some (but not an exhaustive list) of the pruning criteria that can be used.

In the context of content based pruning, by using metadata and hints from the content management system (through virtual descriptors or other means), the on-demand encapsulation engine can determine the transform sessions that correspond to contents that do not provide significant quality increases at higher bit-rates. From this point, the architecture is adapted to choose to prune the profiles.

In the context of concurrency/popularity based pruning, by favoring profiles that are more popular, the on-demand encapsulation engine can attain better efficiencies by allowing more clients to request the popular profiles and, thereby, increasing the caching gains at the ODE complex. In the context of user/subscription tier based pruning, where the ODE is performed at the edge of the CDN, SLA based pruning actions can be performed.

For the server load definitions, any number of parameters can be used, many of which may be based on particular architecture needs. For example, the server load definition can include the following utilization levels (although the present disclosure is not limited to these parameters): a) CPU utilization; b) memory footprint/utilization; c) ingress and egress network utilization; and d) storage 10.

Turning to FIG. 1E, FIG. 1E is a simplified table associated with example workflows involving load based target alteration. This particular example considers a given time interval (e.g., T1, T2, etc.), a number of sessions (e.g., 1, 200, 300, etc.), a resource condition (e.g., overload, OK, etc.), and an action. For example, the first action in the table is associated with sending fragments and manifest with all profiles in which no bandwidth control is provided for sessions. As the number of sessions increases from 1 to 200, the action remains the same. However, at T3, where the number of sessions has jumped to 300, the resource condition indicates an overload. At this junction, the action can include applying fairness logic and throttling session bandwidth for ODE transform sessions. At T4, the number of sessions has stabilized and the resource condition has improved to an OK status. For this reason, the action involves continuing to throttle and maintaining the current sessions.

At 102, a request for content is received from a client. For example, the request can be received by a given origin server, a virtual server, and cache server, etc. At 104, a policy is identified for a particular transform. This identification can be performed by any suitable entity such as the component that received the request. At 106, the resource monitor is accessed in order to evaluate the current load conditions. At 108, a determination is made as to which actions should be taken. For example, the origin server could indicate that it is already running a multitude of sessions such that it can signal that certain transforms should be limited a certain bit-rate, a certain bandwidth, etc.

At 110, during a next time interval, new sessions may arise (and there may be new resources available). As part of the new transform sessions (or more generally, transform objects), a new policy can be enforced (e.g., based on some improving conditions), which is reflected at 112. For example, more profiles can be added at this juncture.

At 114, for the proactive notifications, when the session is already in progress, and an event happens such that the existing bit-rate cannot be maintained, the clients can be forced to downshift to a lower bit-rate profile. For this case, the resource monitor can send a notification to each of the transform sessions (or objects) to indicate an action to throttle down, as illustrated in 116. The clients could then respond by no longer sending the high-bit-rate requests into the system. Note that in producing the output manifest file, the transform sessions (or objects) would simply not include that profile for the clients. Hence, for existing clients, better resource utilization can be achieved.

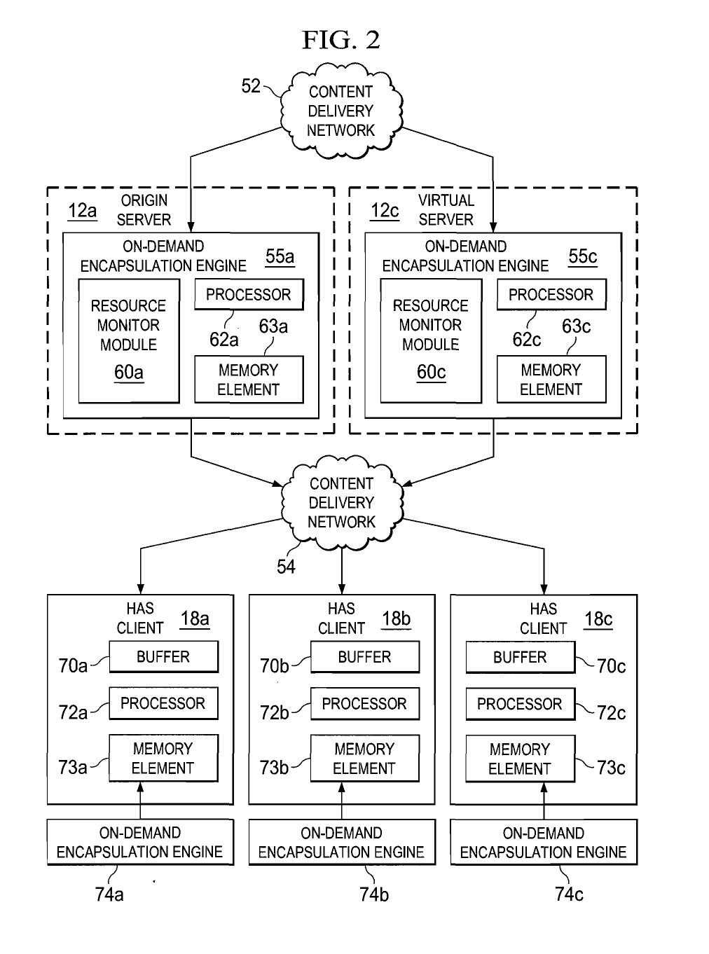

Turning to FIG. 2, FIG. 2 is a simplified block diagram illustrating one possible architecture that may be associated with the present disclosure. FIG. 2 illustrates the flexibility associated with the present disclosure in that an on-demand encapsulation engine may be provisioned in any suitable location (e.g., within an origin server, within a virtual server, within a cache server, within a client device, etc.). This particular example illustrates the on-demand encapsulation engine being provisioned in origin server 12a, virtual server 12c, and within several HAS clients 18a-c. Each of these elements can include a respective on-demand encapsulation engine 55a, 55c, and 74a-c. Additionally, origin server 12a and virtual server 12c can include a respective resource monitor module 60a-c, a respective processor 62a-c, and a respective memory element 63a-c. Each of HAS clients 18a-c can include a respective buffer 70a-c, a respective processor 72a-c, and a respective memory element 73a-c. Note that any of the server implementations discussed herein can operate somewhat independently, without having to upgrade each of the client devices to accommodate the teachings of the present disclosure. In other cases, each of the clients can cooperate with the servers in executing (or at least sharing) some of the responsibilities associated with load based target alterations, as discussed herein.

Referring briefly back to certain internal structure that could be used to accomplish the teachings of present disclosure, HAS clients 18a-c can be associated with devices, customers, or end users wishing to receive data or content in communication system 10 via some network. The term ‘HAS client’ and ‘client device’ is inclusive of any devices used to initiate a communication, such as any type of receiver, a computer, a set-top box, an Internet radio device (IRD), a cell phone, a smartphone, a laptop, a tablet, a personal digital assistant (PDA), a Google Android™, an iPhone™, an iPad™, a Microsoft Surface™, or any other device, component, element, endpoint, or object capable of initiating voice, audio, video, media, or data exchanges within communication system 10. HAS clients 18a-c may also be inclusive of a suitable interface to the human user, such as a display, a keyboard, a touchpad, a remote control, or any other terminal equipment. HAS clients 18a-c may also be any device that seeks to initiate a communication on behalf of another entity or element, such as a program, a database, or any other component, device, element, or object capable of initiating an exchange within communication system 10. Data, as used herein in this document, refers to any type of numeric, voice, video, media, audio, or script data, or any type of source or object code, or any other suitable information in any appropriate format that may be communicated from one point to another.

Transcoder 17 (or a multi-bitrate encoder) is a network element configured for performing one or more encoding operations. For example, transcoder 17 can be configured to perform direct digital-to-digital data conversion of one encoding to another (e.g., such as for movie data files or audio files). This is typically done in cases where a target device (or workflow) does not support the format, or has a limited storage capacity that requires a reduced file size. In other cases, transcoder 17 is configured to convert incompatible or obsolete data to a better-supported or more modern format.

Network 16 represents a series of points or nodes of interconnected communication paths for receiving and transmitting packets of information that propagate through communication system 10. Network 16 offers a communicative interface between sources and/or hosts, and may be any local area network (LAN), wireless local area network (WLAN), metropolitan area network (MAN), Intranet, Extranet, WAN, virtual private network (VPN), or any other appropriate architecture or system that facilitates communications in a network environment. A network can comprise any number of hardware or software elements coupled to (and in communication with) each other through a communications medium.

In one particular instance, the architecture of the present disclosure can be associated with a service provider digital subscriber line (DSL) deployment. In other examples, the architecture of the present disclosure would be equally applicable to other communication environments, such as an enterprise wide area network (WAN) deployment, cable scenarios, broadband generally, fixed wireless instances, fiber-to-the-x (FTTx), which is a generic term for any broadband network architecture that uses optical fiber in last-mile architectures, and data over cable service interface specification (DOCSIS) cable television (CATV). The architecture can also operate in junction with any 3G/4G/LTE cellular wireless and WiFi/WiMAX environments. The architecture of the present disclosure may include a configuration capable of transmission control protocol/internet protocol (TCP/IP) communications for the transmission and/or reception of packets in a network.

In more general terms, servers 12a-f are network elements that can facilitate the load based target alteration activities discussed herein. As used herein in this Specification, the term ‘network element’ is meant to encompass any of the aforementioned elements, as well as routers, switches, cable boxes, gateways, bridges, data center elements, loadbalancers, firewalls, inline service nodes, proxies, servers, processors, modules, or any other suitable device, component, element, proprietary appliance, or object operable to exchange information in a network environment. These network elements may include any suitable hardware, software, components, modules, interfaces, or objects that facilitate the operations thereof. This may be inclusive of appropriate algorithms and communication protocols that allow for the effective exchange of data or information.

In one implementation, HAS clients 18a-c and/or servers 12a-f include software to achieve (or to foster) the load based target alteration activities discussed herein. This could include the implementation of instances of resource monitor modules 60, transform session management modules 57, on-demand encapsulation engines 55, and/or any other suitable element that would foster the activities discussed herein. Additionally, each of these elements can have an internal structure (e.g., a processor, a memory element, etc.) to facilitate some of the operations described herein. In other embodiments, these load based target alteration activities may be executed externally to these elements, or included in some other network element to achieve the intended functionality. Alternatively, HAS clients 18a-c and/or servers 12a-f may include software (or reciprocating software) that can coordinate with other network elements in order to achieve the load based target alteration activities described herein. In still other embodiments, one or several devices may include any suitable algorithms, hardware, software, components, modules, interfaces, or objects that facilitate the operations thereof.

In certain alternative embodiments, the load based target alteration techniques of the present disclosure can be incorporated into a proxy server, web proxy, cache, CDN, etc. This could involve, for example, instances of resource monitor modules 60, transform session management modules 57, on-demand encapsulation engines 55, etc. being provisioned in these elements. Alternatively, simple messaging or signaling can be exchanged between an HAS client and these elements in order to carry out the activities discussed herein.

In operation, a CDN can provide bandwidth-efficient delivery of content to HAS clients 18a-c or other endpoints, including set-top boxes, personal computers, game consoles, smartphones, tablet devices, iPads™, iPhones™, Google Droids™, Microsoft Surfaces™, customer premises equipment, or any other suitable endpoint. Note that servers 12a-f (previously identified in FIG. 1A) may also be integrated with or coupled to an edge cache, gateway, CDN, or any other network element. In certain embodiments, servers 12a-f may be integrated with customer premises equipment (CPE), such as a residential gateway (RG).

As identified previously, a network element can include software (e.g., resource monitor modules 60, transform session management modules 57, on-demand encapsulation engines 55, etc.) to achieve the load based target alteration operations, as outlined herein in this document. In certain example implementations, the load based target alteration functions outlined herein may be implemented by logic encoded in one or more non-transitory, tangible media (e.g., embedded logic provided in an application specific integrated circuit [ASIC], digital signal processor [DSP] instructions, software [potentially inclusive of object code and source code] to be executed by a processor [processors shown in FIG. 2], or other similar machine, etc.). In some of these instances, a memory element [memories shown in FIG. 2] can store data used for the operations described herein. This includes the memory element being able to store instructions (e.g., software, code, etc.) that are executed to carry out the activities described in this Specification. The processor can execute any type of instructions associated with the data to achieve the operations detailed herein in this Specification. In one example, the processor could transform an element or an article (e.g., data) from one state or thing to another state or thing. In another example, the activities outlined herein may be implemented with fixed logic or programmable logic (e.g., software/computer instructions executed by the processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

Any of these elements (e.g., the network elements, etc.) can include memory elements for storing information to be used in achieving the load based target alteration activities, as outlined herein. Additionally, each of these devices may include a processor that can execute software or an algorithm to perform the load based target alteration activities as discussed in this Specification. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ Similarly, any of the potential processing elements, modules, and machines described in this Specification should be construed as being encompassed within the broad term ‘processor.’ Each of the network elements can also include suitable interfaces for receiving, transmitting, and/or otherwise communicating data or information in a network environment.

Note that while the preceding descriptions have addressed certain ABR management techniques, it is imperative to note that the present disclosure can be applicable to other protocols and technologies (e.g., Microsoft Smooth™ Streaming (HSS™), Apple HTTP Live Streaming (HLS™), Adobe Zeri™ (HDS), Silverlight™, etc.). In addition, yet another example application that could be used in conjunction with the present disclosure is Dynamic Adaptive Streaming over HTTP (DASH), which is a multimedia streaming technology that could readily benefit from the techniques of the present disclosure. DASH is an adaptive streaming technology, where a multimedia file is partitioned into one or more segments and delivered to a client using HTTP. A media presentation description (MPD) can be used to describe segment information (e.g., timing, URL, media characteristics such as video resolution and bitrates). Segments can contain any media data and could be rather large. DASH is codec agnostic. One or more representations (i.e., versions at different resolutions or bitrates) of multimedia files are typically available, and selection can be made based on network conditions, device capabilities, and user preferences to effectively enable adaptive streaming. In these cases, communication system 10 could perform appropriate load based target alteration based on the individual needs of clients, servers, etc.

Additionally, it should be noted that with the examples provided above, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that communication system 10 (and its techniques) are readily scalable and, further, can accommodate a large number of components, as well as more complicated/sophisticated arrangements and configurations. Accordingly, the examples provided should not limit the scope or inhibit the broad techniques of communication system 10, as potentially applied to a myriad of other architectures.

It is also important to note that the steps in the preceding FIGURES illustrate only some of the possible scenarios that may be executed by, or within, communication system 10. Some of these steps may be deleted or removed where appropriate, or these steps may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by communication system 10 in that any suitable arrangements, chronologies, configurations, and timing mechanisms may be provided without departing from the teachings of the present disclosure.

It should also be noted that many of the previous discussions may imply a single client-server relationship. In reality, there is a multitude of servers in the delivery tier in certain implementations of the present disclosure. Moreover, the present disclosure can readily be extended to apply to intervening servers further upstream in the architecture, though this is not necessarily correlated to the ‘m’ clients that are passing through the ‘n’ servers. Any such permutations, scaling, and configurations are clearly within the broad scope of the present disclosure.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

What is claimed is:

1. A method, comprising:
receiving, at a virtual server, a request for video content from a client device;
identifying a policy for a set of transform sessions being managed by the virtual server;
accessing a resource monitor in order to evaluate current load conditions associated with the virtual server managing the set of transform sessions; and
determining an action to take based on the current load conditions.

2. The method of claim 1, wherein the current load conditions include a selected one or more of a group of utilization levels, the group consisting of:
a) a central processing unit (CPU) utilization level;
b) a memory utilization level;
c) an ingress and an egress network utilization level; and
d) a storage input/output (IO) level.

3. The method of claim 1, wherein the action includes signaling that at least some of the transform sessions should be limited to a certain bit-rate or a certain bandwidth.

4. The method of claim 1, further comprising:
detecting an overload condition; and
using an on-demand encapsulation engine to determine particular transform sessions that would be subject to pruning or pacing.

5. The method of claim 1, further comprising:
implementing a popularity-based pruning scheme by favoring bit-rate profiles that are more popular to a plurality of client devices; and
pruning bit-rate profiles that are less popular to the plurality of client devices.

6. The method of claim 1, further comprising:
using metadata to determine particular transform sessions that correspond to contents that do not provide significant quality increases at higher bit-rates; and
pruning bit-rate profiles that correspond to the particular transform sessions.

7. The method of claim 1, further comprising:
determining that new resources at the virtual server are available;
generating a new policy based on the new resources; and
adding new bit-rate profiles to be made available to additional client devices.

8. The method of claim 1, further comprising:
providing a proactive notification when a plurality of video sessions are already in progress, wherein the notification is provided in response to an event for which at least one existing bit-rate cannot be maintained for at least some of the video sessions, and wherein the client device is instructed to downshift to a bit-rate profile lower than a current bit-rate profile being used by the client device.

9. The method of claim 1, further comprising:
providing, by the resource monitor, a notification to each of the transform sessions to indicate an action for the client device to throttle down such that the client device responds by no longer sending high-bit-rate requests to the virtual server.

10. The method of claim 4, further comprising:
producing an updated output manifest file, wherein the transform sessions do not include a high-bit-rate profile for the client device.

11. The method of claim 1, wherein the virtual server is operating in conjunction with a Dynamic Adaptive Streaming over HTTP (DASH) protocol, and further comprising:
generating a new period with a modified list of bit-rate profiles within an adaptation set for the new period, wherein new load conditions associated with the virtual server are used to determine certain bit-rate profiles that should be advertised in the new period.

12. The method of claim 1, wherein the virtual server is operating in conjunction with an HTTP Live Streaming (HLS) protocol, and further comprising:
redirecting additional requests for higher bit-rate fragments to equivalent fragments at lower bit-rates.

13. The method of claim 1, wherein the virtual server is operating in conjunction with an HTTP Smooth Streaming (HSS) protocol, and further comprising:
using a composite manifest file that includes a playlist of manifests, wherein the composite manifest is resolved to contain a set of bit-rate profiles associated with new conditions associated with the virtual server.

14. One or more non-transitory tangible media that includes code for execution and when executed by a processor operable to perform operations comprising:
receiving, at a virtual server, a request for video content from a client device;
identifying a policy for a set of transform sessions being managed by the virtual server;
accessing a resource monitor in order to evaluate current load conditions associated with the virtual server managing the set of transform sessions; and
determining an action to take based on the current load conditions.

15. A virtual server, comprising:
a processor;
a memory; and
an on-demand encapsulation engine, wherein the virtual server is configured to:
receive a request for video content from a client device;
identify a policy for a set of transform sessions being managed by the virtual server;
access a resource monitor in order to evaluate current load conditions associated with the virtual server managing the set of transform sessions; and
determine an action to take based on the current load conditions.

16. The virtual server of claim 15, wherein the current load conditions include a selected one or more of a group of utilization levels, the group consisting of:
a) a central processing unit (CPU) utilization level;
b) a memory utilization level;
c) an ingress and an egress network utilization level; and
d) a storage input/output (IO) level.

17. The virtual server of claim 15, wherein the action includes signaling that at least some of the transform sessions should be limited to a certain bit-rate or a certain bandwidth.

18. The virtual server of claim 15, wherein the virtual server is further configured to:
detect an overload condition; and
use an on-demand encapsulation engine to determine particular transform sessions that would be subject to pruning or pacing.

19. The virtual server of claim 15, wherein the virtual server is further configured to:
use metadata to determine particular transform sessions that correspond to contents that do not provide significant quality increases at higher bit-rates; and
prune bit-rate profiles that correspond to the particular transform sessions.

20. The virtual server of claim 15, wherein the virtual server is further configured to:
determine that new resources at the virtual server are available;
generate a new policy based on the new resources; and
add new bit-rate profiles to be made available to additional client devices.
